(19) United States
(12) Patent Application Publication
(10) Pub. No.: US 2025/0142656 A1
(43) Pub. Date: May 1, 2025

(54) OPTIMIZED REMOTE USER PLANE SELECTION PROCESS

(71) Applicant: Cisco Technology, Inc., San Jose, CA (US)

(72) Inventors: Anthony Maswan Fajri, Pleasanton, CA (US); Gautam Mohanlal Borkar, Redmond, WA (US)

(21) Appl. No.: 18/498,733

(22) Filed: Oct. 31, 2023

(51) Int. Cl. H04W 76/16; H04W 48/00; H04W 88/16

(52) U.S. Cl. CPC H04W 76/16; H04W 48/17; H04W 88/16

(57) ABSTRACT

In one aspect, a method includes sending, by a first network gateway component, an echo message to a network device, wherein the echo message is sent over a user plane of a wireless communication network; determining by the network gateway component, whether an echo response is received in response to the echo message; and sending, to a control plane network gateway component of the wireless communication network, a connection failure message upon determining that the echo response is not received, the connection failure message triggering the control plane network gateway component to select a second user plane network gateway component for user plane data communication with the network device.

### BACKGROUND

Fifth generation (5G) mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous generation architectures.

Cellular operators that deploy 5G and/or Long Term Evolution (LTE) networks often rely on remotely deployed User Plane Function (UPF) and user plane Serving Gateway (SGWu)/user plane Packet Data Network Gateway (SGWu/PGWu), to reduce network latency on the user plane. Given that user plane and control plane communications go through different IP backbones in a network, any failure of connectivity to a remote UPF and/or SGWu/PGWu causes traffic black hole that standards do not currently address.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture according to some aspects of the present disclosure;

FIG. 1B illustrates an example fog computing architecture according to some aspects of the present disclosure;

FIG. 2 depicts an exemplary schematic representation of a 5G network environment according to some aspects of the present disclosure;

FIG. 3 illustrates an example configuration of remotely located user plane functions of a 5G/LTE network according to some aspects of the present disclosure;

FIG. 4A illustrates one example of user plane path failure in a specific implementation of configuration of FIG. 3 according to some aspects of the present disclosure;

FIG. 4B illustrates an example procedure for addressing user plane path failure in configuration of FIG. 4A according to some aspects of the present disclosure;

FIG. 5A illustrates one example of user plane path failure in a specific implementation of configuration of FIG. 3 according to some aspects of the present disclosure;

FIG. 5B illustrates an example procedure for addressing user plane path failure in configuration of FIG. 5A according to some aspects of the present disclosure;

FIG. 6A illustrates one example of user plane path failure in a specific implementation of configuration of FIG. 3 according to some aspects of the present disclosure;

FIG. 6B illustrates an example procedure for addressing user plane path failure in configuration of FIG. 6A according to some aspects of the present disclosure;

FIG. 7 is a flow chart of a method for optimized selection of remotely located network components for user plane communication according to some aspects of the present disclosure; and

FIG. 8 shows an example of computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to an optimized process for selecting a remote user plane network components (e.g., UPF, SGWu, PGWu, etc.) for communication when carrying General Packet Radio Service (GPRS) Tunneling Protocol (GTP) for carrying user plane data in a core network of a 3^{rd} Generation Partnership Project (3GPP)-based network including, but not limited to, LTE/4G, 5G, 6G networks as well as future versions thereof. The selection process described herein may be optimized process when a GTPu path failure on a current connection with a remote user plane network component occurs.

In one aspect, a method includes sending, by a first network gateway component, an echo message to a network device, wherein the echo message is sent over a user plane of a wireless communication network; determining by the network gateway component, whether an echo response is received in response to the echo message; and sending, to a control plane network gateway component of the wireless communication network, a connection failure message upon determining that the echo response is not received, the connection failure message triggering the control plane network gateway component to select a second user plane network gateway component for user plane data communication with the network device.

In another aspect, the echo message is sent upon receiving a Create Session Request.

In another aspect, the first network gateway component is a user plane packet data network gateway (PGWu) and the network device is a user plane serving gateway (SGWu).

In another aspect, the echo message is sent during a session modification request.

In another aspect, the first network gateway is a co-located user plane packet data network gateway (PGWu) and a user plane serving gateway (SGWu) and the network device is an eNode-B.

In another aspect, the echo message is sent during a session management (SM) update process.

In another aspect, the first network gateway component is a user plane function (UPF) and the network device is gNode-B.

In one aspect, a network component includes one or more memories including computer-readable instructions stored therein, and one or more processors. The one or more processors are configured to execute the computer-readable instructions to send an echo message to a network device, wherein the echo message is sent over a user plane of a wireless communication network; determine whether an echo response is received in response to the echo message; and send a connection failure message to a control plane network component upon determining that the echo response is not received, the connection failure message triggering the control plane network component to select a second network component for user plane data communication with the network device.

In one aspect, one or more non-transitory computer-readable media include computer-readable instructions, which when executed by one or more processors of a user plane network component of a wireless network, cause the network component to send an echo message to a network device, wherein the echo message is sent over the user plane of the wireless communication network; determine whether an echo response is received in response to the echo message; and send a connection failure message to a control plane network component of the wireless network upon determining that the echo response is not received, the connection failure message triggering the control plane network component to select a second user plane network component for user plane data communication with the network device.

### Example Embodiments

As noted above, cellular operators may deploy remote UPF, SGWu and/or PGWu components to reduce latency on the user plane when carrying GTPu data. However, due to any number of reasons, a user plane connection to such remotely deployed UPF, SGWu and/or PGWu may fail (may be referred to as a path failure). Furthermore, selection of a remotely connected UPF, SGWu/PGWu may occur on proximity and geographical area considerations.

Furthermore, in 3GPP-based networks, user plane and control plane communications may occur over different IP backbones. This separation in connectivity between user plane and control plane communications may cause a number of issues.

For instance, a failure on a control plane path may cause session establishment to perform redundant retry mechanisms. As far as the user plane is concerned, a path failure may cause (1) for remote PGWu deployments (which may mostly be deployed by MVNOs), a path failure between SGWu and PGWu will cause a traffic black hole, because the path failure is not visible to a control plane PGW (PGWc); and (2) for remote UPF and Collocated-S/PGWu (mostly deployed by cellular operators), a path failure between gNode-B and/or an eNode-B and UPF/SGWu may cause a session to reconnect after being established. This can cause signaling storm and bad user experience.

Aspects of the present disclosure described herein address the possible traffic black hole and signaling storm on the user plane when a path failure occurs.

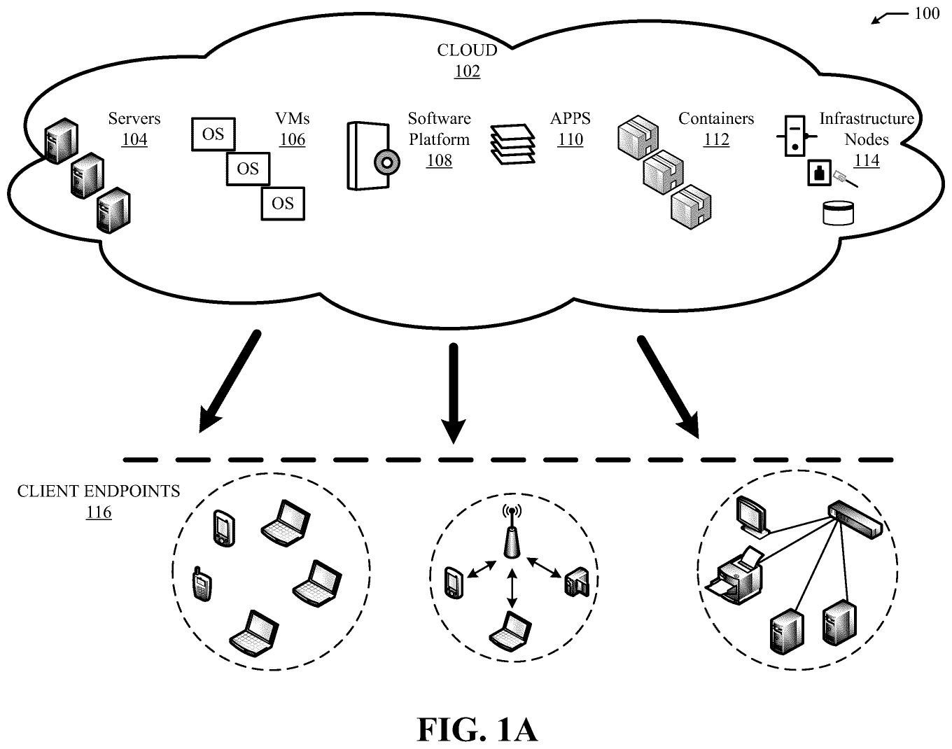

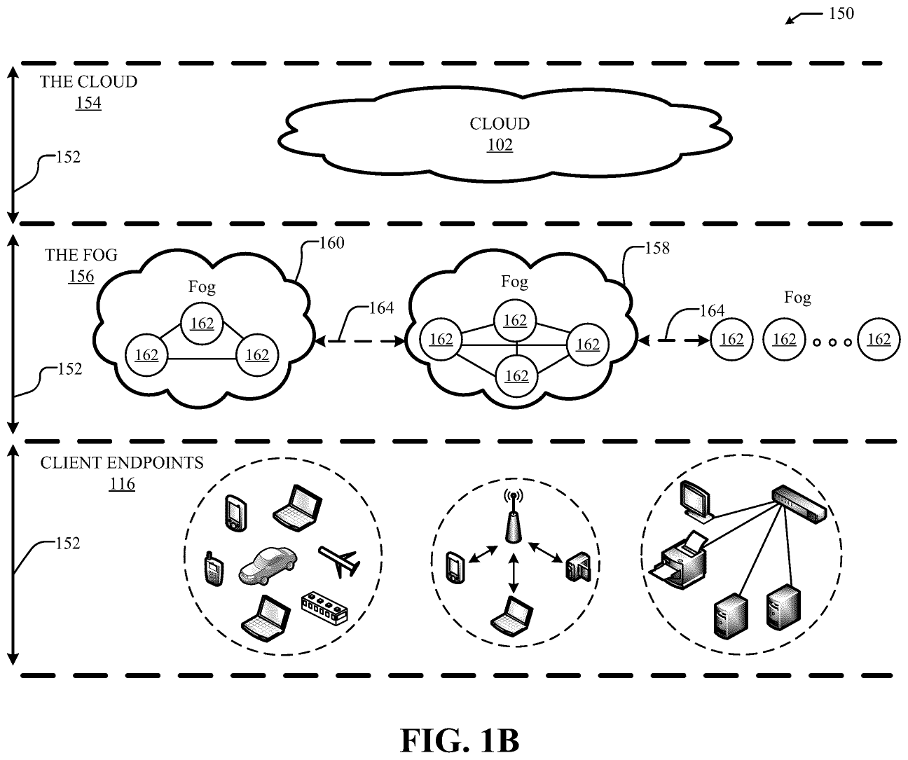

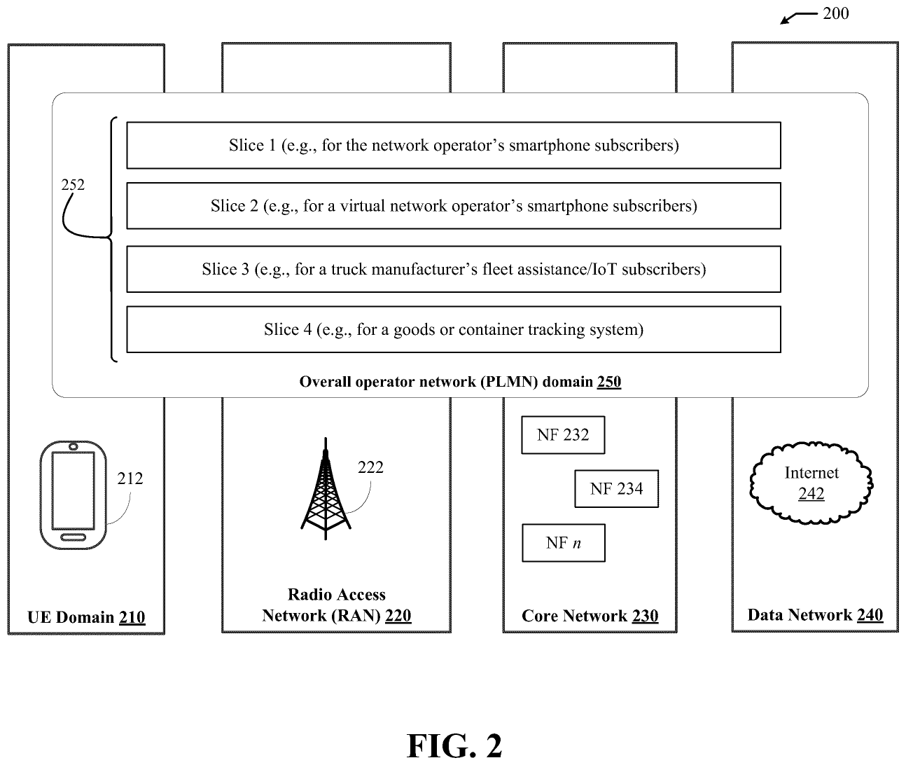

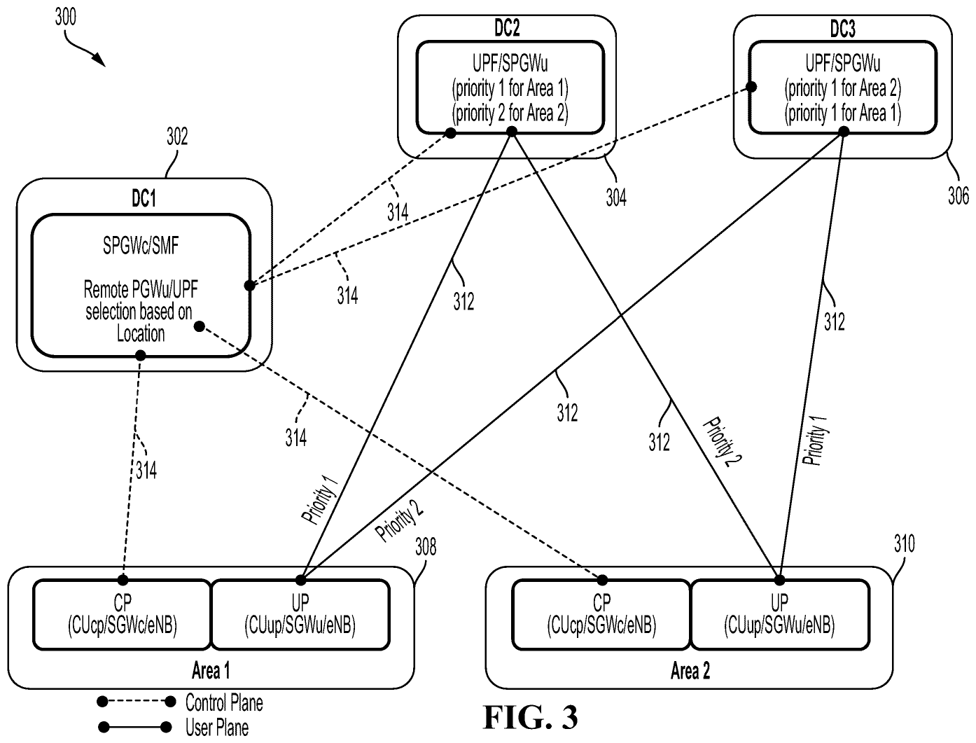

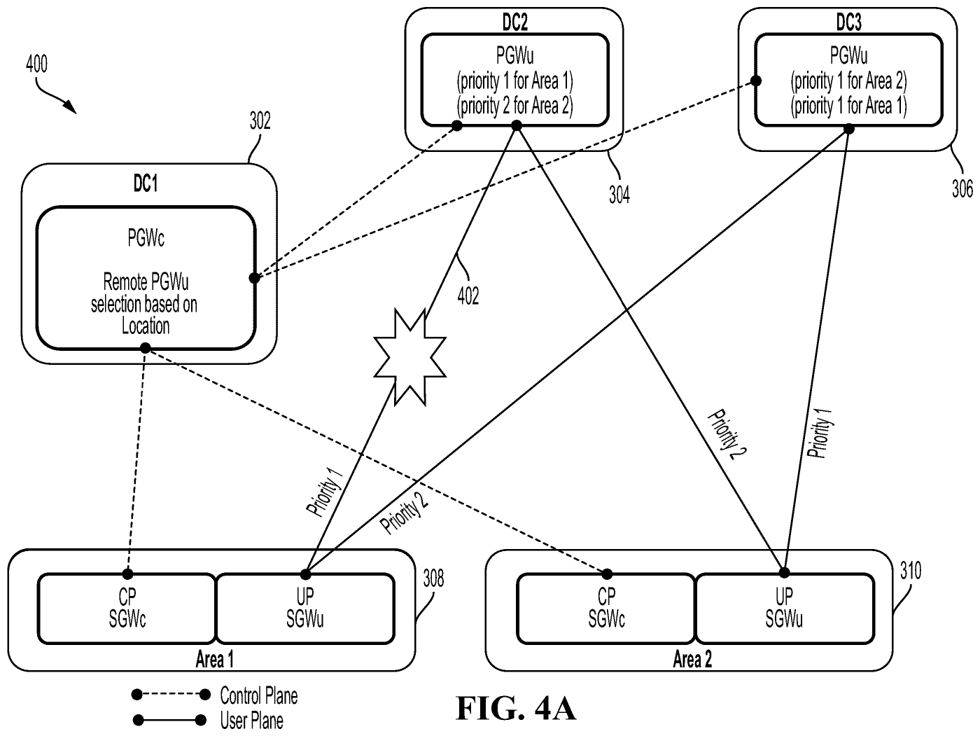

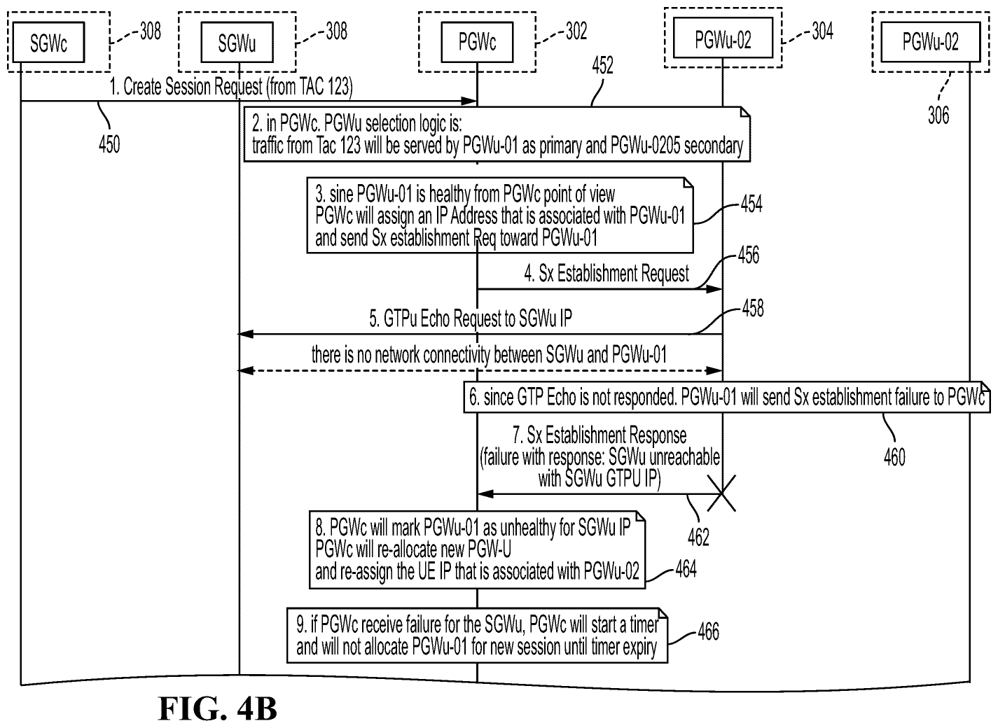

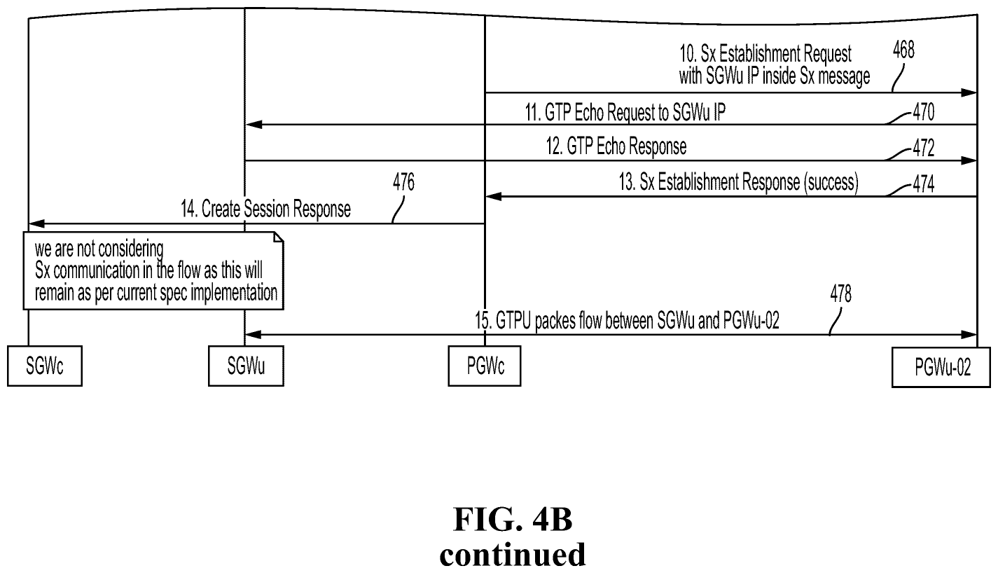

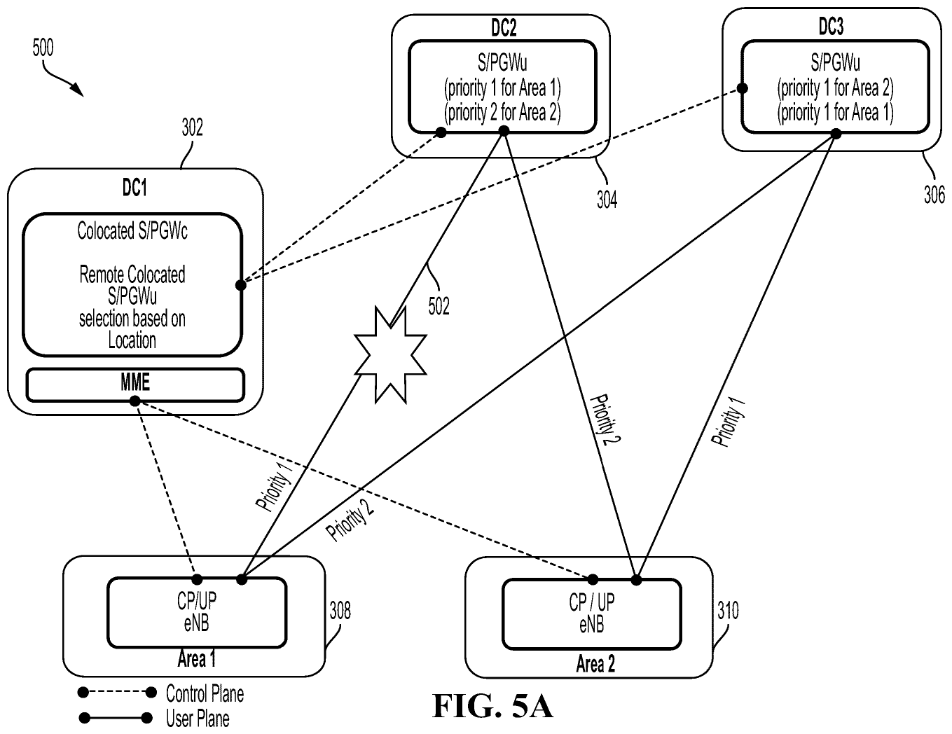

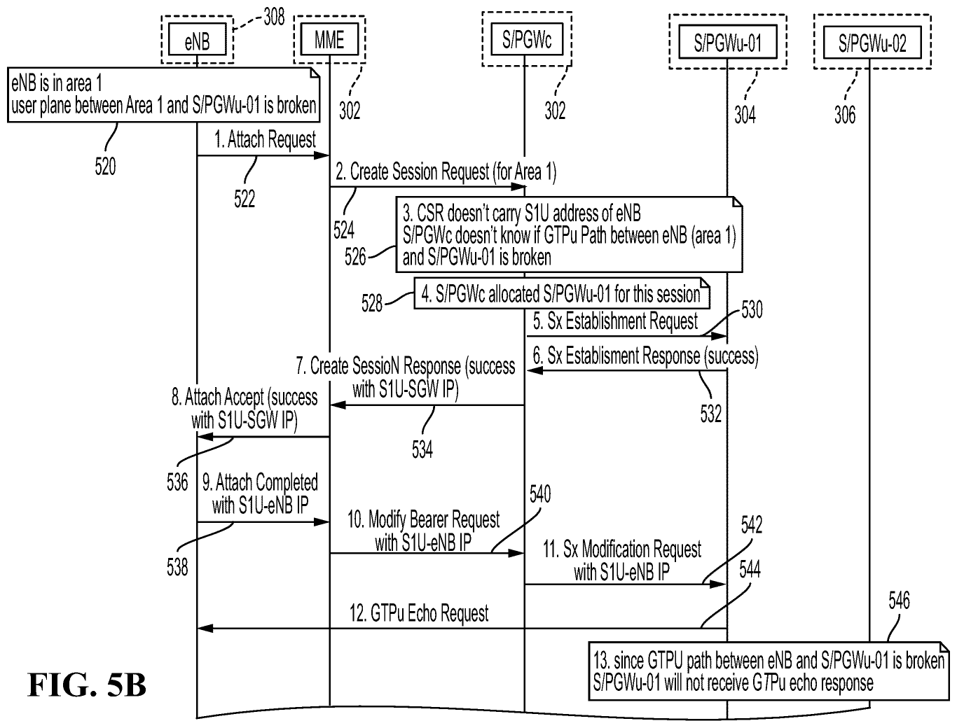

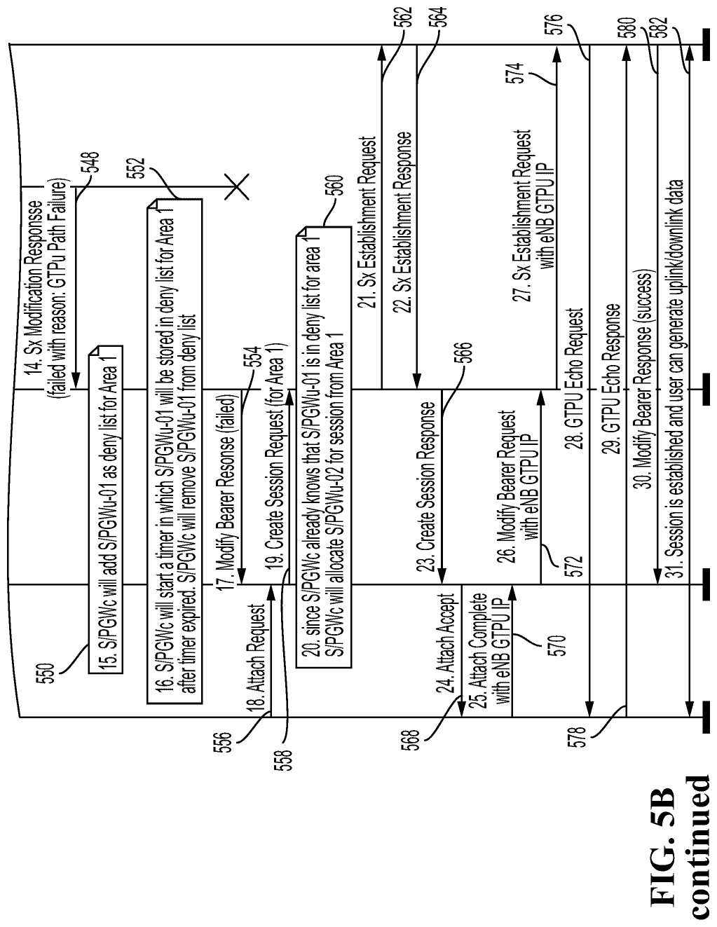

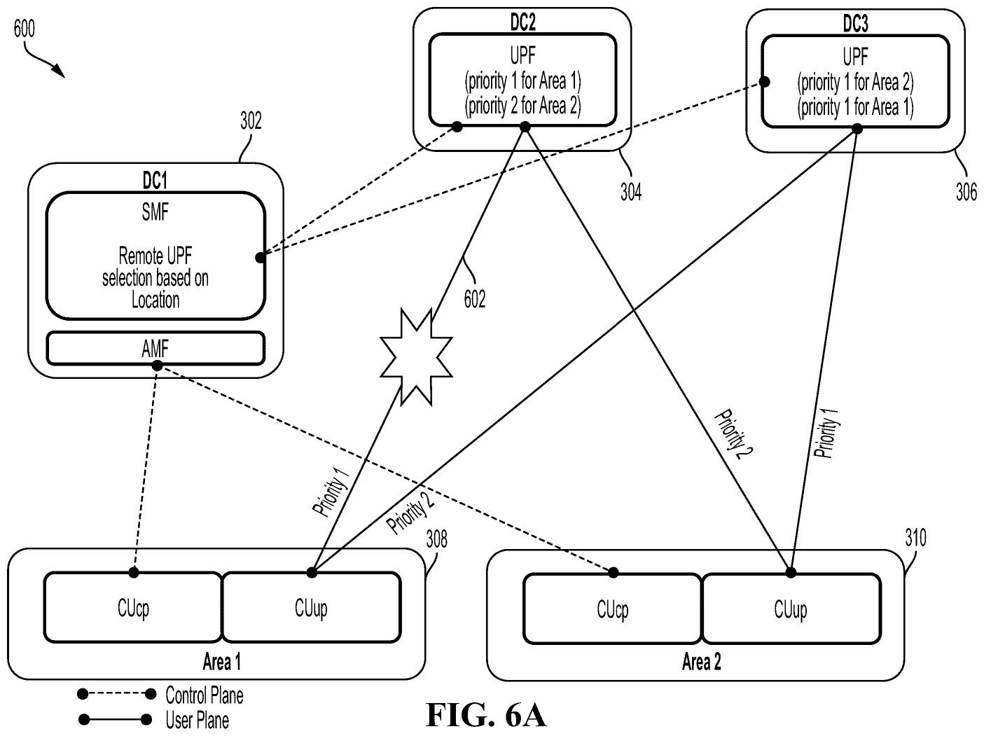

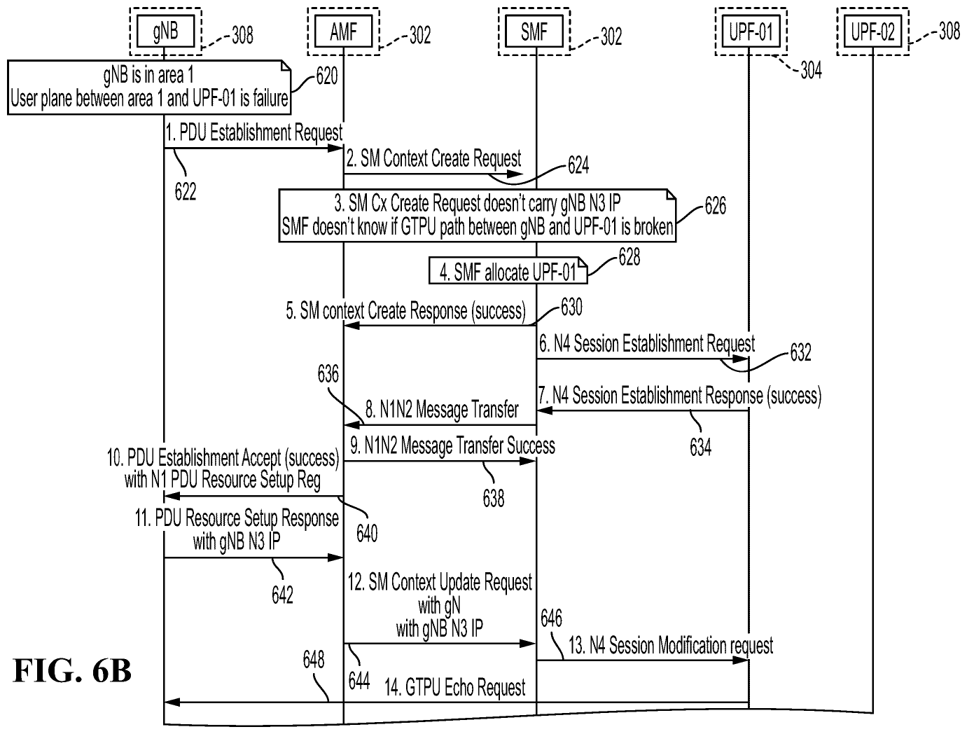

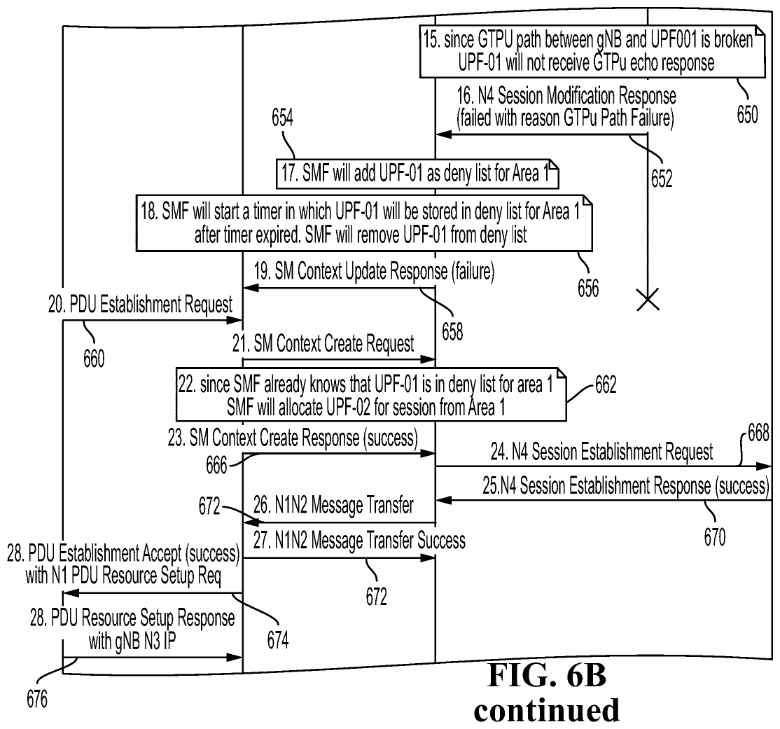

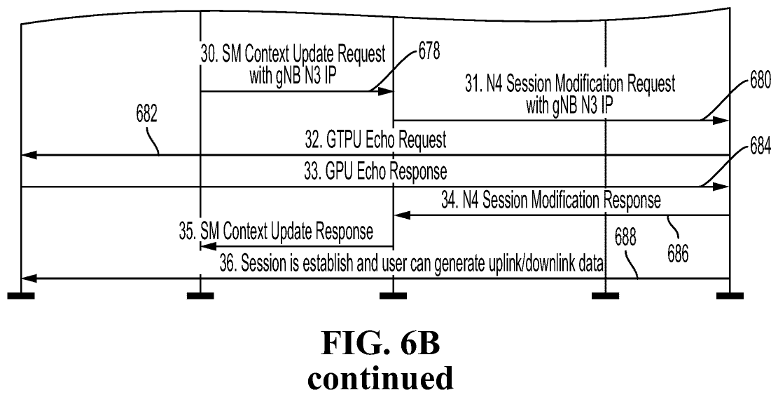

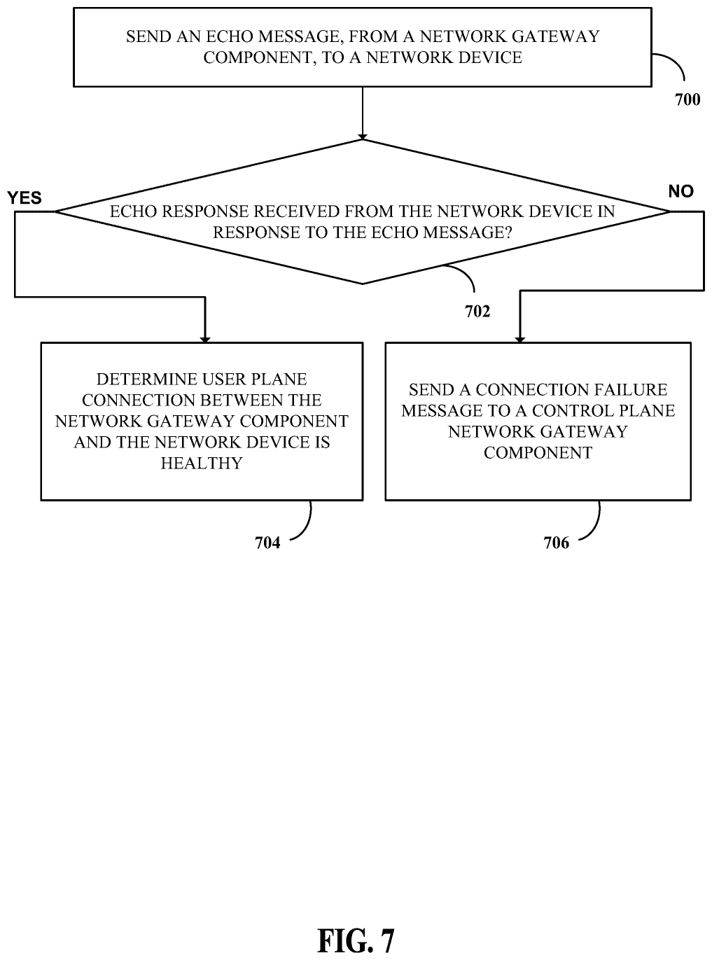

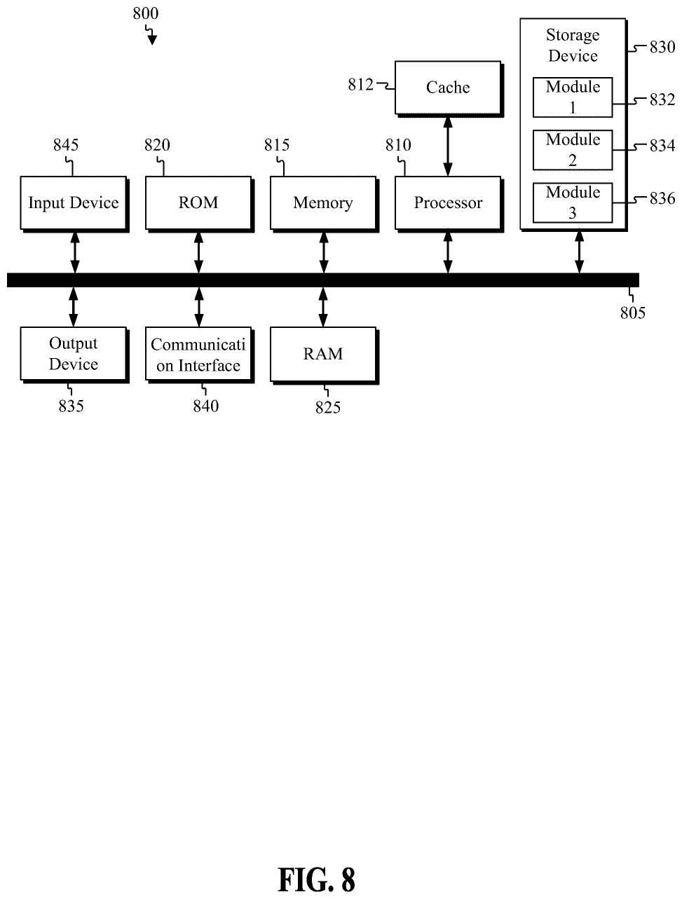

Example network architectures in which aspects of the present disclosure may be implemented are described with reference to FIGS. 1A-B, FIG. 2, and FIG. 3. Optimized user plane selection process are then described with reference to FIGS. 4A-B, FIGS. 5A-B, FIGS. 6A-B, and FIG. 7. The discussion then concludes with a brief description of example devices, as illustrated in FIG. 8.

FIG. 1A illustrates a diagram of an example cloud computing architecture 100. The architecture can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 158 can be local or regional clouds or networks. For example, the fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud 154 while located at the starting location and switch to a different physical and/or logical connection point with the cloud 154 while located at the destination location. The particular fog node can thus move within particular clouds and/or fog instances and, therefore, serve endpoints from different locations at different times.

FIG. 2 depicts an exemplary schematic representation of a 5G network environment 200 in which network slicing has been implemented, and in which one or more aspects of the present disclosure may operate. Non-limiting example 5G network environment 200 can be implemented as part of the example enterprise networks of FIGS. 1A-B. Furthermore, while a 5G network is being described with reference to FIG. 2 as a non-limiting example of a 3GPP network, the present disclosure is not limited thereto. For instance, instead of or in addition to a 5G network, a 4G/LTE network, a 6G network, and/or any other 3GPP-based network may be used.

As illustrated, network environment 200 is divided into four domains, each of which will be explained in greater depth below; a User Equipment (UE) domain 210, e.g. of one or more enterprise, in which a plurality of user cellphones or other connected devices 212 reside; a Radio Access Network (RAN) domain 220, in which a plurality of radio cells, base stations, towers, or other radio infrastructure 222 resides; a Core Network 230, in which a plurality of Network Functions (NFs) 232, 234, . . . , n reside; and a Data Network 240, in which one or more data communication networks such as the Internet 242 reside. Additionally, the Data Network 240 can support SaaS providers configured to provide SaaSs to enterprises, e.g., to users in the UE domain 210.

Core Network 230 contains a plurality of Network Functions (NFs), shown here as NF 232, NF 234 . . . . NF n. In some embodiments, core network 230 is a 5G core network (5GC) in accordance with one or more accepted 5GC architectures or designs. In some embodiments, core network 230 is an Evolved Packet Core (EPC) network, which combines aspects of the 5GC with existing 4G networks. Regardless of the particular design of core network 230, the plurality of NFs typically execute in a control plane of core network 230, providing a service based architecture in which a given NF allows any other authorized NFs to access its services. For example, a Session Management Function (SMF) controls session establishment, modification, release, etc., and in the course of doing so, provides other NFs with access to these constituent SMF services.

In some embodiments, the plurality of NFs of core network 230 can include one or more Access and Mobility Management Functions (AMF; typically used when core network 230 is a 5GC network) and Mobility Management Entities (MME; typically used when core network 230 is an EPC network), collectively referred to herein as an AMF/MME for purposes of simplicity and clarity. In some embodiments, an AMF/MME can be common to or otherwise shared by multiple slices of the plurality of network slices 252, and in some embodiments an AMF/MME can be unique to a single one of the plurality of network slices 252.

The same is true of the remaining NFs of core network 230, which can be shared amongst one or more network slices or provided as a unique instance specific to a single one of the plurality of network slices 252. In addition to NFs comprising an AMF/MME as discussed above, the plurality of NFs of the core network 230 can additionally include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across these four domains of the 5G network environment 200, an overall operator network domain 250 is defined. The operator network domain 250 is in some embodiments a Public Land Mobile Network (PLMN), and can be thought of as the carrier or business entity that provides cellular service to the end users in UE domain 210. Within the operator network domain 250, a plurality of network slices 252 are created, defined, or otherwise provisioned in order to deliver a desired set of defined features and functionalities, e.g., SaaSs, for a certain use case or corresponding to other requirements or specifications. Note that network slicing for the plurality of network slices 252 is implemented in end-to-end fashion, spanning multiple disparate technical and administrative domains, including management and orchestration planes (not shown). In other words, network slicing is performed from at least the enterprise or subscriber edge at UE domain 210, through the Radio Access Network (RAN) 120, through the 5G access edge and the 5G core network 230, and to the data network 240. Moreover, note that this network slicing may span multiple different 5G providers.

For example, as shown here, the plurality of network slices 252 include Slice 1, which corresponds to smartphone subscribers of the 5G provider who also operates network domain, and Slice 2, which corresponds to smartphone subscribers of a virtual 5G provider leasing capacity from the actual operator of network domain 250. Also shown is Slice 3, which can be provided for a fleet of connected vehicles, and Slice 4, which can be provided for an IoT goods or container tracking system across a factory network or supply chain. Note that these network slices 252 are provided for purposes of illustration, and in accordance with the present disclosure, and the operator network domain 250 can implement any number of network slices as needed, and can implement these network slices for purposes, use cases, or subsets of users and user equipment in addition to those listed above. Specifically, the operator network domain 250 can implement any number of network slices for provisioning SaaSs from SaaS providers to one or more enterprises.

5G mobile and wireless networks will provide enhanced mobile broadband communications and are intended to deliver a wider range of services and applications as compared to all prior generation mobile and wireless networks. Compared to prior generations of mobile and wireless networks, the 5G architecture is service based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous generation architectures.

Within the scope of the 5G mobile and wireless network architecture, a network slice comprises a set of defined features and functionalities that together form a complete Public Land Mobile Network (PLMN) for providing services to UEs. This network slicing permits for the controlled composition of a PLMN with the specific network functions and provided services that are required for a specific usage scenario. In other words, network slicing enables a 5G network operator to deploy multiple, independent PLMNs where each is customized by instantiating only those features, capabilities and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g., based on requirements of the services, to the enterprise.

Associating SaaSs and SaaS providers with network slices used to provide the SaaSs to enterprises can facilitate efficient management of SaaS provisioning to the enterprises. Specifically, it is desirable for an enterprise/subscriber to associate already procured SaaSs and SaaS providers with network slices actually being used to provision the SaaSs to the enterprise. However, associating SaaSs and SaaS providers with network slices is extremely difficult to achieve without federation across enterprises, network service providers, e.g., 5G service providers, and SaaS providers.

FIG. 3 illustrates an example configuration of remotely located user plane functions of a 5G/LTE network according to some aspects of the present disclosure. As shown, example configuration 300 can include multiple remotely located core functionalities implemented in different data centers in different geographical locations. For instance, control plane SGW/PGW (may collectively be referred to as SPGWc) and/or SMF may be located in DC1 302. Two different SPGWu/UPF functionalities may be implemented in two other data centers such as DC2 304 and DC3 306.

Furthermore, last mile network components for providing user connectivity may be in two different areas, area1 308 and area2 310. Each of ears 308 and 310 may include Control Plane (CP) such as base stations (e.g., gNode-B, e-NodeB, etc.), Control Unit Control Plane (CUcp), SGWc, and e-NodeB as well as User Plane (UP) components and functionalities Control Unit User Plane (CUup), SGWu, e-NodeB, etc.

In one example, SPGWu/UPF in DC2 304 may serve as a primary user plane connection for last mobile components and end user devices connected thereto in area1 308 while SPGWu/UPF in DC3 306 may service as a backup user plane connection for area1 308. Conversely, SPGWu/UPF in DC3 306 may serve as a primary user plane connection for area2 310 while SPGWu/UPF in DC2 304 services as a backup user plane connection for area1 308. Furthermore, in FIG. 3, user plane connections are shown using solid connection lines 312 while control plane connections are shown using dashed connection lines 314. Control plane connections are separate connections between PGWc in DC1 302 and components in each of DC2 304, DC3 306, area1 308 and area2 310.

FIG. 4A illustrates one example of user plane path failure in a specific implementation of configuration of FIG. 3 according to some aspects of the present disclosure.

Example configuration 400 is one in which only PGWu is remotely implemented in DC2 304 and DC3 306. This example configuration may be implemented by Mobile Virtual Network Operators (MVNOs). Example user plane path failure may occur on user plane connection 402 between SGWu in area1 308 and PGWu in DC2 304.

As noted above, user plane and control plane communications may occur over different IP backbones and hence different IP addresses. Prior to path failure (connection failure) on connection 402, a user plane connection between SGWu in area1 308 and SGWu in DC2 304 is already established. In establishing this connection, a create session request from TAC 123 is communicated by SGWc (e.g., in area1 308) to PGWc in DC1 302. In response PGWc in DC1 302 establishes PGWu in DC2 304 as primary PGWu for SGWu in area1 308 and PGWu in DC3 306 as backup for SGWu in area1 308.

At this point, PGWu in DC2 304 appears healthy and active to PGWc in DC1 302. Therefore, PGWc in DC1 302 assigns an IP address to PGWu in DC2 304 to use for communication with SGWu in area1 308 and sends Sx establishment request to PGWu in DC2 304. PGWc in DC1 302 receives an Sx establishment response back from PGWu in DC2 304 and establishes a user plane connection between PGWu in DC2 304 and SGWu in area1 over connection 402. Given the connectivity over different IP addresses, path failure on connection 402 remains unknown to PGWc in DC1 302 such that PGWc in DC1 302 cannot reconfigure and switch SGWu in area1 308 to switch from primary PGWu in DC2 304 to backup PGWu in DC3 306. This causes GPTu traffic between SGWu in area1 308 and PGWu in DC2 304 to be blackholed.

FIG. 4B illustrates an example procedure for addressing user plane path failure in configuration of FIG. 4A according to some aspects of the present disclosure. Steps 450, 452, 454, and 456 of FIG. 4B may be performed as described above and/or according to any known or to be developed and established signaling procedures, which may be adopted and standardized from time to time. Hence for sake of brevity will not be described in detail.

At step 458 and in response to receiving a Sx establishment request, PGWu in DC2 304 sends an echo signal (may also be referred to as GTPu echo signal, echo message, and/or echo request) to SGWu in area1 308 in order to determine the health of connection 402. Given the example path failure, SGWu in area1 308 does not receive the echo signal and hence will not respond thereto, as shown in step 460.

At step 462, PGWu in DC2 304 sends an Sx establishment failure to PGWc in DC1 302 (with reporting reason SGWu unreachable). In response at step 464, PGWc in DC1 302 marks PGWu in DC2 304 as unhealthy for SGWu in area1 308 and its associated IP. PGWc in DC1 302 reassigns SGWu in area1 308 to PGWu in DC3 306 with a new IP address.

At step 466, PGWc in DC1 302 may start a timer and will not allocate PGWu in DC2 304 for a new session with SGWu in area1 308 until the timer expiry (duration of such timer and expiration thereof may be a configurable parameter determined based on experiments and/or empirical studies).

At step 468, PGWc in DC1 302 sends an Sx establishment request to the newly associated PGWu in DC3 306 (for SGWu in area1 308). Similar to step 458, at step 470 PGWu in DC3 306 sends an echo signal to SGWu in area1 308. At step 472, PGWu in DC3 306 receives an echo response from SGWu in area1 308 indicating the connection therebetween (e.g., connection 410) as healthy. At step 474, PGWu in DC3 306 sends an Sx establishment response (success) to PGWc in DC1 302. At step 476, PGWc in DC1 302 sends a session establishment response to SGWc in area1 308 (in response to an initial create session request (TAC 123) as described above). At step 478, user plane connection between SGWu in area1 308 and PGWu in DC3 306 is established and user plane communication may occur therebetween.

Accordingly, by implementing steps 458 to 478, a user plane path failure in FIG. 4A does not result in user plane traffic between SGWu in area1 308 and PGWu in DC2 304 to be black holed.

FIG. 5A illustrates one example of user plane path failure in a specific implementation of configuration of FIG. 3 according to some aspects of the present disclosure.

Example configuration 500 is one in which SGWu and PGWu (SPGWu) are collocated in DC2 304 and DC3 306 and user plane communication occurs between eNode-Bs in area1 308 and area2 310 and SPGWu in DC2 304 and/or DC3 306. Example user plane path failure may occur on user plane connection 502 between eNode-B in area1 308 and SPGWu in DC2 304 and may remain unknown to PGWc in DC1 302 due to control plane and user plane communications being carried over different IP backbones, as described above. In contrast to configuration 300 of FIG. 3, SPGWc are also collocated in DC1 302 along with a 5G MME. eNode-Bs are in area1 308 and area2 310.

In this example scenario, eNode-B in area1 308 sends an attachment request to MME in DC1 302, which MME then shares with SPGWc in DC1 302. SPGWc assigns SPGWu in DC2 304 to eNode-B in area1 308. Since Create Session Request (CSR) does not carry the S1U address of eNode-B in area1 308, SPGWc in DC1 302 does not know that connection 502 is broken and continues to allocate SPGWu in DC2 306 for the requested session by eNode-B in area1 308. Therefore, upon establishing a session, user plane traffic from eNode-B in area1 308 to and from SPGWu in DC2 304 would be blackholed.

FIG. 5B illustrates an example procedure for addressing user plane path failure in configuration of FIG. 5A according to some aspects of the present disclosure. Steps 520, 522, 524, 526, 528, 530, 532, 534, 536, 538, and 540 of FIG. 5B may be performed as described above and/or according to any known or to be developed and established signaling procedures, which may be adopted and standardized from time to time. Hence for sake of brevity will not be described in detail.

At step 542, SPGWu in DC2 306 receives an Sx modification request with SIU address of eNode-B in area1 308. In response, at step 544, SPGWu in DC2 306 sends an echo signal (similar to example echo signal described with reference to FIG. 4B) to eNode-B in area1 308. At step 546, SPGWu in DC2 306 does not receive an echo response back from eNode-B in area1 308 since connection 502 is broken.

Therefore, at step 548, SPGWu in DC2 306 sends an Sx modification response (failed with reason: GTPu Path Failure) to SPGWc in DC1 302.

At step 550, SPGWc in DC1 302 adds SPGWu in DC2 306 to a deny list for area1 308. At step 552, SPGWc in DC1 302 starts a timer for storing SPGWu in DC2 306 in the deny list until expiration (duration of such timer and expiration thereof may be a configurable parameter determined based on experiments and/or empirical studies).

Thereafter, at step 554, SPGWc in DC1 302 responds to MME with a modify bearer request (failed).

At step 556, MME may receive a subsequent attach request from eNode-B in area1 308. In response and at step 558, MME in DC1 302 sends a create session request (for area1 308) to SPGWc in DC1 302. Since SPGWc in DC1 302 knows that SPGWu in DC2 306 is in a deny list for area1 308, at step 560, SPGWc in DC1 302 assigns SPGWu in DC3 306 for the requested session with eNode-B in area1 308.

Remaining steps 562, 564, 566, 568, 570, 572, 574, 576, 578, 580, and 582 shown in FIG. 5B may be performed as described above and/or according to any known or to be developed and established signaling procedures, which may be adopted and standardized from time to time. Hence for sake of brevity will not be described in detail.

Accordingly, by implementing steps 520-582, a user plane path failure in FIG. 5A does not result in user plane traffic between eNode-B in area1 308 and SPGWu in DC2 304 to be black holed.

FIG. 6A illustrates one example of user plane path failure in a specific implementation of configuration of FIG. 3 according to some aspects of the present disclosure.

Example configuration 600 is one in which UPF is remotely implemented in DC2 304 and DC3 306 and user plane communication occurs between gNode-Bs in area1 308 and area2 310 and UPFs in DC2 304 and DC3 306. Each gNode-B is shown as having CUcp and CUup functionalities in each of area1 308 and area2 310.

Example user plane path failure may occur on user plane connection 602 between gNode-B in area1 308 and UPF in DC2 304 and may remain unknown to SMF in DC1 302 due to control plane and user plane communications being carried over different IP backbones, as described above. In contrast to configuration 300 of FIG. 3, SMF and AMF are collocated in DC1 302. gNode-Bs are in area1 308 and area2 310.

FIG. 6B illustrates an example procedure for addressing user plane path failure in configuration of FIG. 6A according to some aspects of the present disclosure. Steps 620, 622, 624, 626, 628, 630, 632, 634, 636, 638, 640, 642, 644, and 646 of FIG. 6B may be performed as described above and/or according to any known or to be developed and established signaling procedures, which may be adopted and standardized from time to time. Hence for sake of brevity will not be described in detail.

As can be seen from steps 620-646, because of the failure of connection 602, SM Context (Cx) request at step 626 does not carry the N3 IP address of gNode-B in area1 308 and hence SMF does not know if GTPu path between gNode-B in area1 308 and UPF in DC2 304 is broken.

Therefore, during SM Context Update process, at step 644, AMF in DC1 302 sends an SM Context Update Request to SMF in DC1 302 with N3 IP address of gNode-B in area1 308.

In response and at step 646, SMF in DC1 302 sends an N4 Session Modification Request to UPF in DC2 304. This triggers UPF in DC2 304 to send an echo signal to gNode-B in area1 308 at step 648.

At step 650 and since connection 502 is broken, UPF in DC2 304 does not receive an echo response from gNode-B in area1 308 in response to the echo signal sent. Therefore, at step 652, UPF in DC2 304 sends an N4 Session Modification Response (Failed with reason: GTPu Path Failure).

Similar to steps described with reference to FIG. 5B, in response to this N4 Session Modification Request, SMF in DC1 302 adds UPF in DC2 304 to a deny list for area1 308, at step 654. At step 656, SMF in DC1 302 starts a timer during which UPF in DC2 304 is maintained in the deny list (duration of such timer and expiration thereof may be a configurable parameter determined based on experiments and/or empirical studies). In one example, once the timer expires, SMF in DC1 302 removes UPF in DC2 308 from the deny list for area1 308.

Thereafter, steps 658, 660, 662, 664, 666, 668, 670, 672, 674, 676, 678, 680, 682, 684, 686, and 688 may be performed as described above and/or according to any known or to be developed and established signaling procedures, which may be adopted and standardized from time to time. Hence for sake of brevity will not be described in detail.

Through various implementation of remote user plane communication in a 3GPP-based network such as those described above with reference to FIGS. 4A-B, 5A-B, and 6A-B, the present disclosure provides an optimized procedure for selecting a remote user plane component for data communication.

FIG. 7 is a flow chart of a method for optimized selection of remotely located network components for user plane communication according to some aspects of the present disclosure.

At step 700, a first network gateway component (or more generally a network component or a user plane network component) may send an echo message to a network device.

In one example, the echo message may be sent in response to a Create Session Request received from a control plane network gateway component such as SGWc in area1 308 as described with reference to FIGS. 4A-B. In this instance, the first network gateway component can be the PGWu in DC2 304 while the network device can be the SGWu in area1 308 as described with reference to FIGS. 4A-B.

In another example, the echo message may be sent during a session modification request. In this instance, the first network gateway component can be the SPGWu in DC2 304 while the network device can be the eNode-B in area1 308 as described with reference to FIGS. 5A-B.

In another example, the echo message may be sent during a session management (SM) update process. In this instance, the first network gateway component can be the UPF in DC2 304 while the network device can be the gNode-B in area1 308, as described with reference to FIGS. 6A-B.

At step 702, the first network gateway component may determine whether an echo response is received from the network device in response to the echo message sent at step 700. In one example, the first network gateway component may utilize a timer to make a determination as to whether the echo response is received or not. For instance, such timer may have a duration of a few microseconds, milliseconds, seconds, etc. If the echo response is not received before the timer expires, the first network gateway component may determine that the echo response is not received.

If at step 702 the first network gateway determines that the echo response is received, the first network gateway component determines, at step 704, that user plane connection between the first network gateway and the network device is healthy and thus maintains the user plane connection (e.g., connection 402, 502, 602) therebetween.

However, if at step 702, the first network gateway determines that the echo response is not received before the timer is expired, at step 706, the first network controller may send a connection failure message to a control plane network gateway component (or more generally a control plane network component). The connection failure message may trigger the control plane network gateway component to select a second user plane network gateway component (a second user plane network component) for user plane data communication with the network device.

In one example, the control plane network gateway component can be the PGWc in DC1 302 as described with reference to FIGS. 4A-B, the SPGWc in DC1 302 as described with reference to FIGS. 5A-B, and/or SMF in DC1 302 as described with reference to FIGS. 6A-B.

In one example, the second user plane network gateway component can be the PGWu in DC3 306 as described with reference to FIGS. 4A-B, the SPGWu in DC3 306 as described with reference to FIGS. 5A-B, and/or the UPF in DC2 304 as described with reference to FIGS. 6A-B.

FIG. 8 shows an example of computing system according to some aspects of the present disclosure. Example computing system 800 can be for example any computing device making up enterprise network of FIGS. 1A, 1B, FIG. 2, and/or any of wireless network components described with reference to FIGS. 3 through 6A-B including various gateways, base stations such as eNode-Bs, gNode-Bs, etc., and/or servers that implement core network functionalities such as SMF, AMF, UPF, etc. Various components of system 800 may be in communication with each other using connection 805. Connection 805 can be a physical connection via a bus, or a direct connection into processor 810, such as in a chipset architecture. Connection 805 can also be a virtual connection, networked connection, or logical connection.

In some embodiments computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, \ read only memory (ROM) 820, and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
sending, by a first network gateway component, an echo message to a network device, wherein the echo message is sent over a user plane of a wireless communication network;
determining by the network gateway component, whether an echo response is received in response to the echo message; and
sending, to a control plane network gateway component of the wireless communication network, a connection failure message upon determining that the echo response is not received, the connection failure message triggering the control plane network gateway component to select a second user plane network gateway component for user plane data communication with the network device.

2. The method of claim 1, wherein the echo message is sent upon receiving a Create Session Request.

3. The method of claim 2, wherein the first network gateway component is a user plane packet data network gateway (PGWu) and the network device is a user plane serving gateway (SGWu).

4. The method of claim 1, wherein the echo message is sent during a session modification request.

5. The method of claim 4, wherein the first network gateway is a co-located user plane packet data network gateway (PGWu) and a user plane serving gateway (SGWu) and the network device is an eNode-B.

6. The method of claim 1, wherein the echo message is sent during a session management (SM) update process.

7. The method of claim 6, wherein the first network gateway component is a user plane function (UPF) and the network device is gNode-B.

8. A network component comprising:
one or more memories including computer-readable instructions stored therein; and
one or more processors configured to execute the computer-readable instructions to:
send an echo message to a network device, wherein the echo message is sent over a user plane of a wireless communication network;
determine whether an echo response is received in response to the echo message; and
send a connection failure message to a control plane network component upon determining that the echo response is not received, the connection failure message triggering the control plane network component to select a second network component for user plane data communication with the network device.

9. The network component of claim 8, wherein the echo message is sent upon receiving a Create Session Request.

10. The network component of claim 9, wherein the network component is a user plane packet data network gateway (PGWu) and the network device is a user plane serving gateway (SGWu).

11. The network component of claim 8, wherein the echo message is sent during a session modification request.

12. The network component of claim 11, wherein the network component is a co-located user plane packet data network gateway (PGWu) and a user plane serving gateway (SGWu) and the network device is an eNode-B.

13. The network component of claim 8, wherein the echo message is sent during a session management (SM) update process.

14. The network component of claim 6, wherein the network component is a user plane function (UPF) and the network device is gNode-B.

15. One or more non-transitory computer-readable media comprising computer-readable instructions, which when executed by one or more processors of a user plane network component of a wireless communication network, cause the network component to:
send an echo message to a network device, wherein the echo message is sent over the user plane of the wireless communication network;
determine whether an echo response is received in response to the echo message; and
send a connection failure message to a control plane network component of the wireless network upon determining that the echo response is not received, the connection failure message triggering the control plane component to select a second user plane network component for user plane data communication with the network device.

16. The one or more non-transitory computer-readable media of claim 15, wherein the echo message is sent upon receiving a Create Session Request.

17. The one or more non-transitory computer-readable media of claim 16, wherein the network component is a user plane packet data network gateway (PGWu) and the network device is a user plane serving gateway (SGWu).

18. The one or more non-transitory computer-readable media of claim 15, wherein the echo message is sent during a session modification request.

19. The one or more non-transitory computer-readable media of claim 18, wherein the network component is a co-located user plane packet data network gateway (PGWu) and a user plane serving gateway (SGWu) and the network device is an eNode-B.

20. The one or more non-transitory computer-readable media of claim 15, wherein the echo message is sent during a session management (SM) update process, and the network component is a user plane function (UPF) and the network device is gNode-B.
